(19) United States
(12) Patent Application Publication
(10) Pub. No.: US 2016/0292642 A1
(43) Pub. Date: Oct. 6, 2016

(54) ESTIMATING WORKFORCE SKILL GAPS USING SOCIAL NETWORKS

(71) Applicant: Linkedln Corporation, Mountain View, CA (US)

(72) Inventors: Rajat Sethi, Cambridge, MA (US); Vibhu Prakash Saxena, Milpitas, CA (US); Dacheng Zhao, Sacramento, CA (US); Brian Rumao, San Francisco, CA (US); Bimal Sundaran Parakkal, Burlingame, CA (US); Jacob Bollinger, San Francisco, CA (US); Marjorie Elise Garlinghouse, Menlo Park, CA (US)

(21) Appl. No.: 14/755,778

(22) Filed: Jun. 30, 2015

Related U.S. Application Data
(60) Provisional application No. 62/141,253, filed on Mar. 31, 2015.

(51) Int. Cl. G06Q 10/10; G06Q 50/00

(52) U.S. Cl. CPC G06Q 10/1053; G06Q 50/01

(57) ABSTRACT

Estimation of workforce skill gaps using social network services are described herein. An unfilled job is represented by a job posting on a social network service. A skill is predicted as being required for the unfilled job by determining that each member of a set of members has an electronic profile on the social network service listing the skill as possessed by the member. A quantity of unfilled jobs on the social network service requiring the predicted skill is calculated. A quantity of selected job-seeking members of the social network service is calculated, each selected job-seeking member having an electronic profile on the social network service listing the predicted skill as possessed by the selected job-seeking member. A workforce skill gap for the predicted skill is estimated by subtracting the calculated quantity of job-seeking members from the calculated quantity of unfilled jobs.

### CLAIM OF PRIORITY

This patent application claims the benefit of priority under 35 U.S.C. §119(e) to U.S. Provisional Patent Application Ser. No. 62/141,253, filed on Mar. 31, 2015, entitled, “ESTIMATING WORKFORCE SKILL GAPS USING SOCIAL NETWORKS,” which is hereby incorporated by reference herein in its entirety.

### TECHNICAL FIELD

The present disclosure generally relates to social networks hosting member profiles and job postings and, in some embodiments, to techniques for estimating workforce skill gaps using social networks.

### BACKGROUND

A social network service is a computer or web-based application that enables users to establish links or connections with persons for sharing information with one another. Some social networks aim to enable friends and family to communicate with one another, while others are specifically directed to business users with a goal of enabling the sharing of business information.

### BRIEF DESCRIPTION OF THE DRAWINGS

Some embodiments are illustrated by way of example and not limitation in the figures of the accompanying drawings.

FIG. 1 is an illustration of an electronic job posting on a social network service, in accordance with some example embodiments.

FIG. 2 is an illustration of an electronic profile of a member of a social network service, in accordance with some example embodiments.

FIG. 3 is a block diagram showing the functional components of a social network service, including a workforce skill gap module for estimating workforce skill gaps within one or more geographical regions of interest, in accordance with some example embodiments.

FIG. 4 is a flowchart illustrating operations of a skills gap estimation module performing a method for estimating a workforce skill gap for a skill, in accordance with some example embodiments.

FIG. 5 is an illustration of a workforce skill gap report for a skill, in accordance with some example embodiments.

FIG. 6 is a flowchart illustrating another example of operations of a skills gap estimation module performing a method for estimating a set of workforce skill gaps for a set of skills, in accordance with some example embodiments.

FIG. 7 is an illustration of a workforce skill gap report for a set of skills, in accordance with some example embodiments.

FIG. 8 is a block diagram illustrating an example of a machine, upon which any one or more example embodiments may be implemented.

### DETAILED DESCRIPTION

The present disclosure describes methods, systems, and computer program products, each of which provides estimation of workforce skill gaps, for a geographical region of interest, using a social network service. “Skills gap” is a term that describes a disparity between those skills needed for a job and those skills possessed by prospective workers. Existing formal methodologies for quantifying a “skills gap” are either insufficient or are too convoluted. For example, quantifying skills of a labor pool, at either micro or macro levels, has proven to be extremely difficult at any level of geography (e.g., continent, a country, a state, a county, a city, a neighborhood, etc.) Skill gaps can be estimated by government agencies through periodic censuses, where census workers manually collect employment data from households; this is a time and resource-consuming process. Educational data from the Current Population Survey (“CPS”), which is sponsored jointly by the U.S. Census Bureau and the U.S. Bureau of Labor Statistics (“BLS”), can be used by economic and workforce developers as a proxy for “skill level.” This is often inaccurate, as educational data is not necessarily correlated with skills. A more costly, yet still aggregate measure of “skill” is often determined by surveying employers about the types of skills gaps that they encounter in either incumbent or prospective employees.

Some employment initiatives, based on findings of indirect measures of “skills” and “skills gaps,” invest precious time and resources in promoting “skills” that are not in fact needed by employers. Thus, a balanced approach is needed for “skills gap” estimation that incorporates rigorous quantitative methods, uses a direct measure of skills, and has practical application for workforce policy.

Disclosed in some examples herein are methods, systems, and machine-readable mediums, in which a social network service can be used to estimate workforce skill gaps. To estimate workforce skill gaps, the social network service may compare skills possessed by job-seeking members of the social network service with skills required for unfilled job positions posted on the social network service. These workforce skill gaps may be computed for one or more of: a particular industry, a particular geographic region, a particular job type, and the like.

Thus, in some examples, estimating a workforce gap for a skill within a geographical region of interest may be performed by a social network service as follows:

Step 1: calculate a quantity of job-seeking members of a social network service within the geographical region of interest who possess the skill,

Step 2: calculate a quantity of jobs within the geographical region of interest and represented by electronic job postings on the social network service, that are predicted as requiring that skill, and

Step 3: subtract the calculated quantity of social network service members (calculated at step #1) from the calculated quantity of jobs (calculated at step #2) to calculate the estimated workforce skill gap for the skill within the geographical region of interest.

For example, at step 1, the social network service calculates that 435 social network service members within the Denver, Colo. metro area are seeking jobs and possess the skill “C++ Programming”; at step 2, the social network service calculates that 475 unfilled jobs, each with an electronic job posting on the social network service, exist within the Denver, Colo. metro area and require the skill “C++ Programming”; and at step 3, the social network service calculates the workforce skill gap for “C++ Programming” within the Denver, Colo. metro area as equal to 475−435=40 jobs.

To infer the skills necessary for an unfilled job position, the social network service can utilize the skills of the members that view a job listing as an indication of the skills necessary for the unfilled job. For example, the social network service hosts electronic job postings describing an unfilled job and presents members with a summarized view of the electronic job postings (e.g., a list of job postings, each job posting in the list abbreviated to contain the job title, employer, location, etc., but not the full electronic job posting.) The social network service allows its members to search the job postings. Typically, a member of a social network service will not view a full electronic job posting unless the job described is in an employment industry, to which the member belongs. Further, most social network service members will not view a full electronic job posting unless the member has a possibility of being qualified for the job described in the electronic job posting. Thus, the skills possessed by members who have viewed an electronic job posting are a good proxy for the skills required for that job.

In some examples, the workforce skill gap may be determined for a particular geographic area. For a given geographical area, the skills possessed by those members currently associated within that geographical area are a good proxy for the skills available within that geographical area. The location of a member may be determined by their social networking profiles. In some embodiments, each member profile in the social network service lists zero or more geographical locations for the member. For example, a member's profile may list the member's current primary residence, the primary geographical location(s) of the member's current employment position, a list of the member's previous primary residences, a list of geographical locations where the member wishes to visit and/or live, etc. These locations may be listed at varying levels of specificity, from as specific as GPS coordinates (e.g., 41°56′54″N 87°39′20″W) to as general as the name of a continent (e.g., “Africa”.)

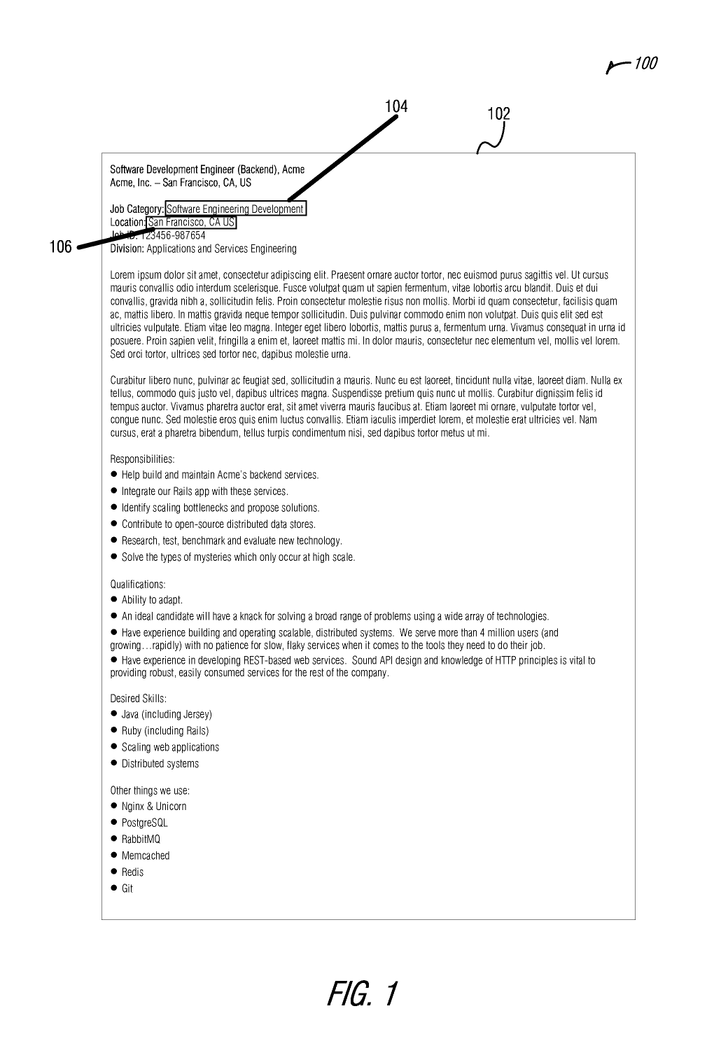

FIG. 1 is an illustration 100 of an electronic job posting 102 on a social network service, in accordance with some example embodiments. An electronic job posting contains at least one job category or employment industry 104, and contains at least one location 106 (e.g., “San Francisco, Calif.”)

In some embodiments, an electronic job posting also contains a job title, a company name, and a job description. The job description may be structured, unstructured, or a combination thereof. An unstructured portion of a job description may contain text describing the job, text that was written by the employer or on the employer's behalf. An unstructured portion of a job description is intended for human consumption, and may be difficult to programmatically analyze and convert to structured data.

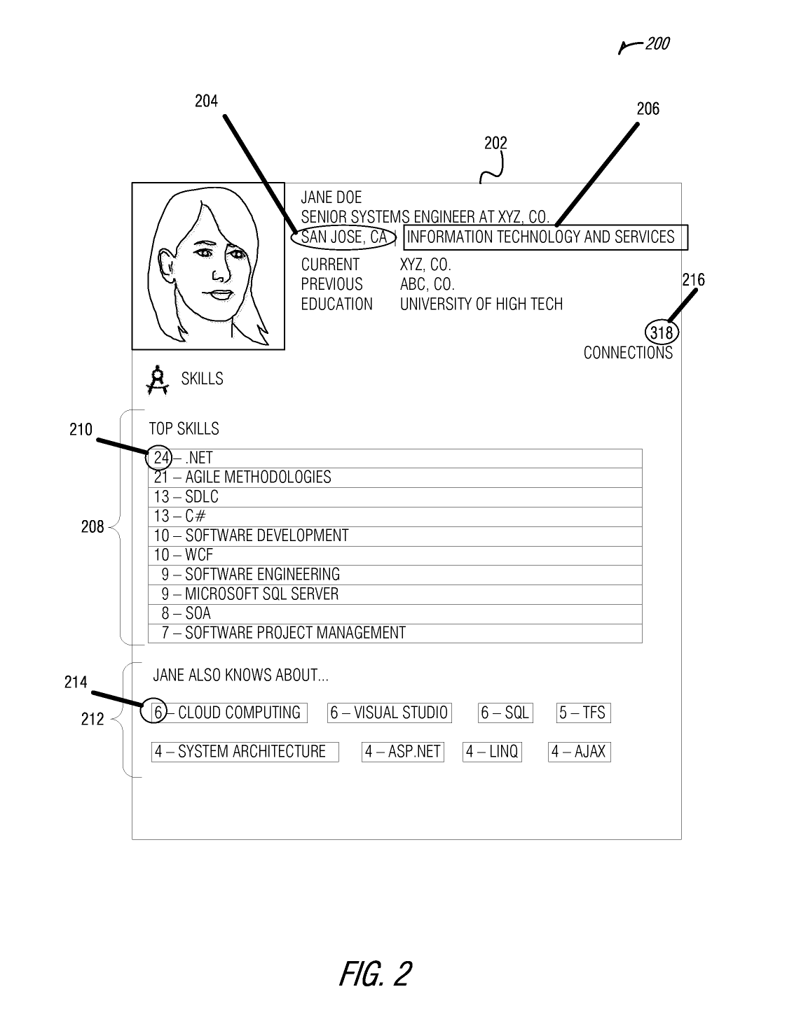

A structured portion of a job description may contain words and/or phrases that are used to describe the responsibilities of the job as well as the qualifications, skills (required and/or desired), and other attributes of intended candidates for the job. As will be described in the description of FIG. 2, a member may list on the member's profile the various skills possessed by the member. These skills are standardized. Programmatic analysis of a structured portion of an electronic job posting may not result in accurate mappings to skills listed on a member's profile. For example, a structured portion of a job posting may list “Microsoft SQL Server” as a required skill, but a first member's profile may list “SQL Server” as possessed by the first member, a second member's profile may list “MS SQL” as possessed by the second member, etc. One solution to this problem is to use the skills of the members that view the job posting. This solution comes from the realization that members typically look at job postings related to their skill sets.

FIG. 2 is an illustration 200 of an electronic profile 202 of a member of a social network service, in accordance with some example embodiments. In some embodiments, the member's electronic profile 202 lists at least one geographical location 204 of the member. In some embodiments, a geographical location 204 is at least one of a continent, a country, a state, a county, a city, a neighborhood, etc. The geographical location 204 may be the location of the member's current primary residence (e.g., “San Jose, Calif.”), a location of the member's primary place of employment, a location of previous primary residences, previous primary places of employment, locations the member wishes to visit, etc.

In some embodiments, the member's electronic profile 202 includes at least one employment industry 206. In some embodiments, the employment industry 206 is one of an industry of the member's primary employer (e.g., “Retail” industry for Target, Inc.), an industry of the member's employment position (e.g., “Information Technology and Services” for a software engineer at Target, Inc.), etc.

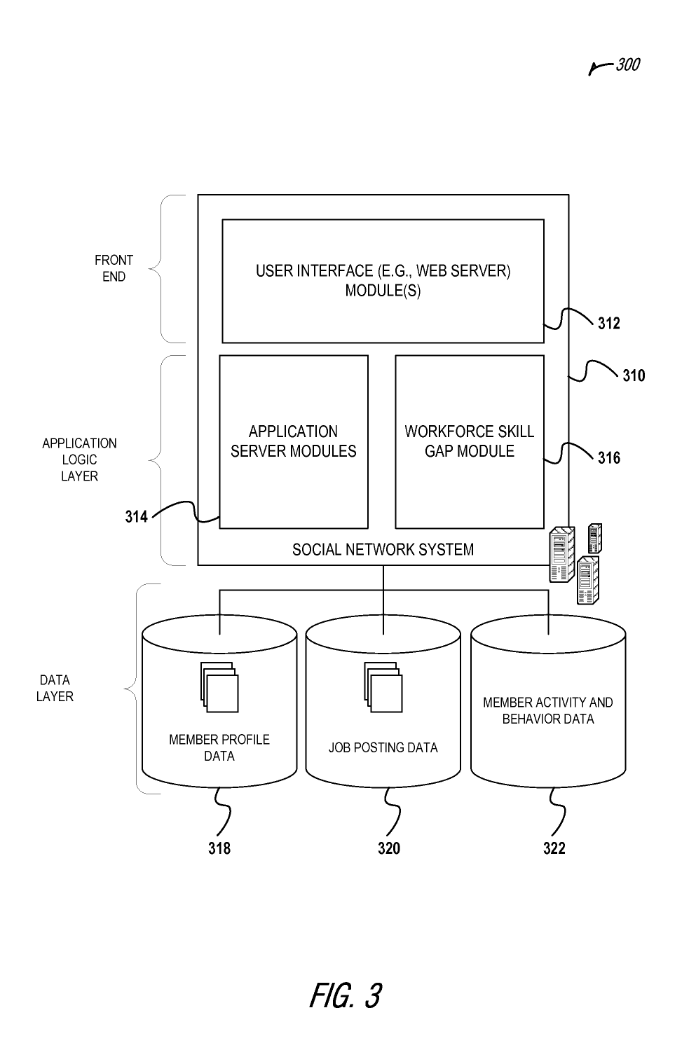

In some embodiments, a member of a social network has zero or more “connections,” which are explained in greater detail in the description of FIG. 3. In some embodiments, the member's electronic profile 202 includes a connection quantity 216, reflecting the current quantity of other member profiles connected to the member's electronic profile 202.

In some embodiments, the member's electronic profile 202 lists zero or more skills 208, 212 as possessed by the member. Each skill listed has zero or more endorsements from other members of the social network service. A skill endorsement may be a positive affirmation that the endorsing member personally knows that the endorsee member possesses the endorsed skill. Skill endorsements are described in U.S. patent application Ser. No. 13/672,377, filed on Nov. 8, 2012 to Jayaram, et al. entitled, “SKILL ENDORSEMENTS.” In some embodiments, an endorsee member can receive a skill endorsement only from endorsing members who are “connected” to the endorsee member, while in other embodiments an endorsee member can receive a skill endorsement from any endorsing member of the social network service, regardless of whether the endorsing member is “connected” to the endorsee member.

In some embodiments, each endorsed skill is associated with a skill endorsement quantity 210, 214 reflecting the current quantity of endorsements the member has received for that skill 208, 212. For example, the skill endorsement quantity 210 shows that twenty-four members of the social network have endorsed Jane for the skill “.NET”. In some embodiments, an endorsing member can endorse an endorsee member only once per skill 208, 212. In some embodiments, the higher a skill endorsement quantity 210, 214 for a skill 208, 212 listed on a member's profile, the more likely the member actually possesses the skill 208, 212.

FIG. 3 is a block diagram 300 showing the functional components of a social network service, including a workforce skill gap module 316 for estimating workforce skill gaps within one or more geographical regions of interest, in accordance with some example embodiments.

As shown in FIG. 3, the front end consists of a user interface module (e.g., a web server) 312, which receives requests from various client-computing devices, and communicates appropriate responses to the requesting client devices. For example, the user interface module(s) 312 may receive requests in the form of Hypertext Transport Protocol (HTTP) requests, or other web-based, application programming interface (API) requests. The application logic layer includes various application server modules 314, which, in conjunction with the user interface module(s) 312, generates various user interfaces (e.g., web pages) with data retrieved from various data sources in the data layer.

In some embodiments, individual application server modules 314 are used to implement the functionality associated with various applications and/or services provided by the social network service. For example, in some embodiments, the social network service may provide an application or service that allows companies and/or people to post information about available job openings—such information generally referred to as a job posting or job listing. This job posting data is stored in job posting database 320. Accordingly, members of the social network service can search for and view available job postings. Job postings may be presented in a content module displayed on some portion of a web page or on a user interface of a mobile device (e.g., phone or tablet computing device). As members interact with the content associated with the job postings, the interactions are detected and logged in member activity and behavior database 322. Accordingly, the nature of the interactions can be used as input data for the workforce skill gap module 316 that estimates workforce skill gaps for a geographical region of interest.

As shown in FIG. 3, the data layer includes several databases, such as a database 318 for storing member profile data. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 318. In some embodiments, the profile data may be processed (e.g., in the background or offline) to generate various derived profile data.

Once registered, a member may invite other members, or be invited by other members, to connect via the social network service. A “connection” may require a bi-lateral agreement by the members, such that both members acknowledge the establishment of the connection. In any case, the various associations and relationships that the members establish with other members, or with other entities and objects, are stored and maintained within the member activity and behavior database 322.

As members interact with the various applications, services, and content made available via the social network service, the members' behavior (e.g., content viewed, links or buttons selected, messages responded to, etc.) may be tracked and information concerning the member's activities and behavior may be logged or stored, for example, as indicated in FIG. 3 by the database with reference number 322. This information may be used to classify the member as being in various classifications or categories. Furthermore, each time a member views an electronic job posting, a link between the member's profile data (which is stored in database 318) and the electronic job posting (which is stored in job posting database 320) is recorded in member activity and behavior database 322.

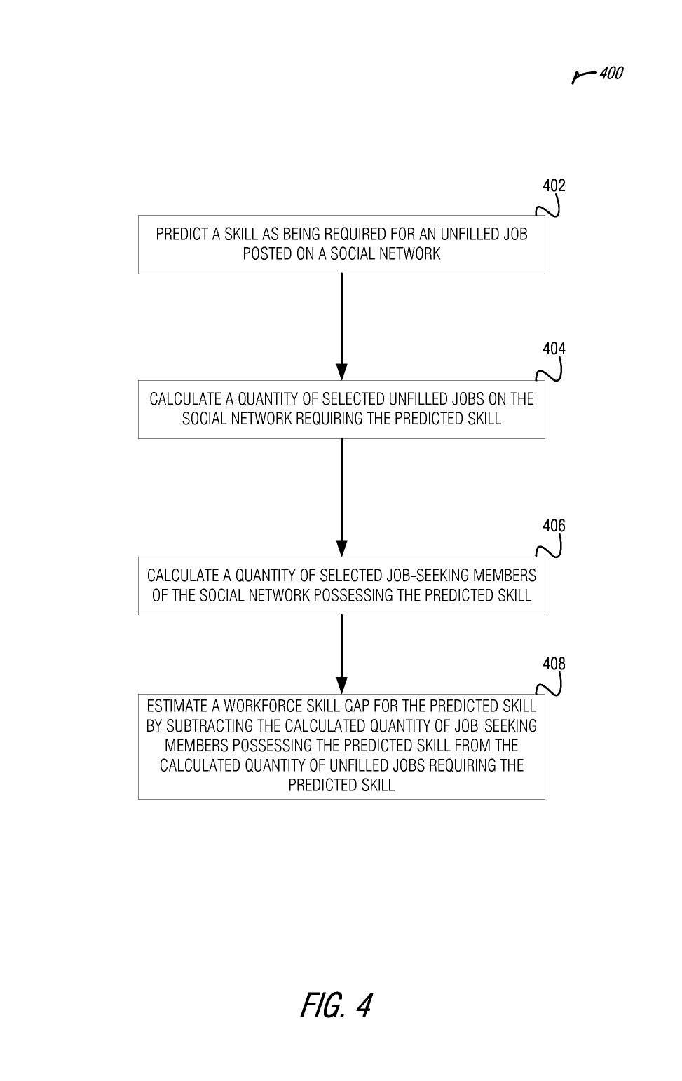

As illustrated in FIG. 3, the social network system includes what is referred to as a workforce skill gap module 316. The workforce skill gap module receives, as input, data from any one or more of the databases 318, 320, and 322, and derives for one or more selected regions of interest, an estimation of the workforce skills gap for the region(s). The operation of the workforce skill gap module is described in greater detail below in connection with the descriptions of FIGS. 4-7.

Although not shown, in some embodiments, the social network system 310 provides an application programming interface (API) module, via which applications and services can access various data and services provided or maintained by the social network service. Such applications may be browser-based applications, or may be operating system-specific. In particular, some applications may reside and execute on one or more mobile devices (e.g., smartphone, or tablet computing devices) with a mobile operating system. Furthermore, while in many cases the applications or services that leverage the API may be applications and services that are developed and maintained by the entity operating the social network service, in some embodiments, the API is provided to the public or to certain third-parties under special arrangements, thereby making the workforce skill gap estimation services available to third party applications and services.

FIG. 4 is a flowchart illustrating operations of a skills gap estimation module performing a method for 400 estimating a workforce skill gap for a skill, in accordance with some example embodiments.

At 402, a skill is predicted as being required for an unfilled job. The unfilled job is represented by an electronic job posting on a social network service. In some embodiments, the predicting is performed by analyzing the skills corresponding to the members who view the electronic job posting. For example, the social network service may infer that the skill is required for the job by determining that the skill is present in more than a predetermined amount or percentage of member profiles of members that viewed the electronic job posting.

Various techniques can be used to infer the set of skills required by an unfilled job. As an example, a minimum percentage (e.g., 50%) of viewing members must possess a skill before that skill is considered as being required for the unfilled job. As another example, a minimum number (e.g., 10) of viewing members must possess a skill before that skill is considered as being required for the unfilled job. As a further example, a minimum percentage (e.g., 50%) and a minimum number (e.g., 10) of viewing members must possess a skill before that skill is considered as being required for the unfilled job. Other techniques may also be used.

At 404, a quantity of selected unfilled jobs on the social network service requiring the predicted skill is calculated. This calculated quantity of selected unfilled jobs represents the employment “demand” for the predicted skill.

In an embodiment, an electronic job posting on the social network service may be assigned to one or more employment industries. In some embodiments, the employment industries that are assignable to an electronic job posting overlap, while in other embodiments, the employment industries that are assignable to an electronic job posting do not overlap. In an embodiment, an unfilled job requiring a predicted skill is selected, at least partially, based on at least one employment industry assigned to the electronic job posting representing the unfilled job. For example, each selected unfilled job in a set of selected unfilled jobs may have been assigned to the “information technology and services” industry. Thus, in this example, the calculated quantity of selected unfilled jobs represents the employment “demand” of unfilled jobs requiring the predicted skill within the “information technology and services” industry.

In some embodiments, various artifacts (e.g., electronic job postings, electronic member profiles, etc.) within the social network service may have one or more geographical regions associated with the artifact. The size of a geographical region may be as small as a city block, as large as a set of continents, or any level in between a city block and a set of continents (e.g., the size of a city, multiple cities, a county, multiple counties, a state, multiple states, a country, multiple countries, etc.)

In some embodiments, an electronic job posting on the social network service may be assigned to one or more geographical locations. The size of a geographical region may be as small as a city block, as large as a set of continents, or any level in between a city block and a set of continents (e.g., the size of a city, multiple cities, a county, multiple counties, a state, multiple states, a country, multiple countries, etc.) In some embodiments, each unfilled job requiring the predicted skill is selected, at least partially, based on at least one geographical region assigned to the unfilled job. For example, each selected unfilled job may be located, primarily or otherwise, in “San Jose, Calif.” Thus, in this example, the calculated quantity of selected unfilled jobs represents the employment “demand” for the predicted skill within San Jose, Calif.

In some embodiments, a job-seeking propensity of a member of the social network service is determined. Determining a job-seeking propensity of a member of a social network service is described in U.S. patent application Ser. No. 13/682,033, filed on Nov. 20, 2012 to Posse, et al. entitled, “TECHNIQUES FOR QUANTIFYING THE JOB-SEEKING PROPENSITY OF MEMBERS OF A SOCIAL NETWORK SERVICE,” which is hereby incorporated by reference in its entirety. A job-seeking propensity algorithm may analyze a variety of input data—including member profile data, social graph data, and activity or behavior data—to derive a job-seeker score, representing the job-seeking propensity of a member. Based on the job-seeker score, the member may be classified as an “active” job-seeker, a “passive” job-seeker, or a non-job-seeker.

At 406, a quantity of selected job-seeking members of the social network service is calculated. In some embodiments, the selected job-seeking members each have an “active” job-seeking propensity, a “passive” job-seeking propensity, or some combination thereof. In some embodiments, each selected job-seeking member has an electronic profile, on the social network service, listing the predicted skill as possessed by the selected job-seeking member. This calculated quantity of selected job-seeking members represents the employment “supply” for the predicted skill.

In some embodiments, each job-seeking member is selected, at least partially, based on at least one geographical region of the job-seeking member. For example, each selected job-seeking member may have a profile that designates the job-seeking member currently resides in, is originally from, or is seeking a job in a geographical region. For example, the electronic profile of each selected job-seeking member on the social network service may have “San Jose, Calif.” as the member's current primary residence. Thus, in this example, the calculated quantity of selected job-seeking members represents the employment “supply” for the predicted skill within San Jose, Calif.

In some embodiments, a member's electronic profile on the social network service lists one or more employment industries of the member. In some embodiments, the employment industries available to be listed on a member's electronic profile are the same employment industries that are assignable to an electronic job posting. In some embodiments, a member's electronic profile lists an employment industry for a current, past, and/or desired employment position of the member. In some embodiments, each job-seeking member is selected, at least partially, based on an employment industry listed on the profile of the job-seeking member. For example, each job-seeking member may be selected based on each member's electronic profile listing “Civil Litigation” as the member's current employment industry. In this example, the calculated quantity of selected job-seeking members represents the employment “supply” for the predicted skill in the “Civil Litigation” industry.

At 408, a workforce skill gap for the predicted skill is estimated. In some embodiments, the estimation is performed by subtracting the quantity of job seeking members possessing the predicted skill (“skill supply,” calculated at 406) from the quantity of unfilled jobs requiring the predicted skill (“skill demand,” calculated at 404). A positive workforce skill gap estimate indicates that there are more unfilled jobs requiring the predicted skill than there are members possessing the predicted skill. A negative indicates that there are fewer unfilled jobs requiring the predicted skill than there are members possessing the predicted skill. A workforce skill gap estimate of zero indicates that the quantity of unfilled jobs requiring the predicted skill is equal to the quantity of members possessing the predicted skill.

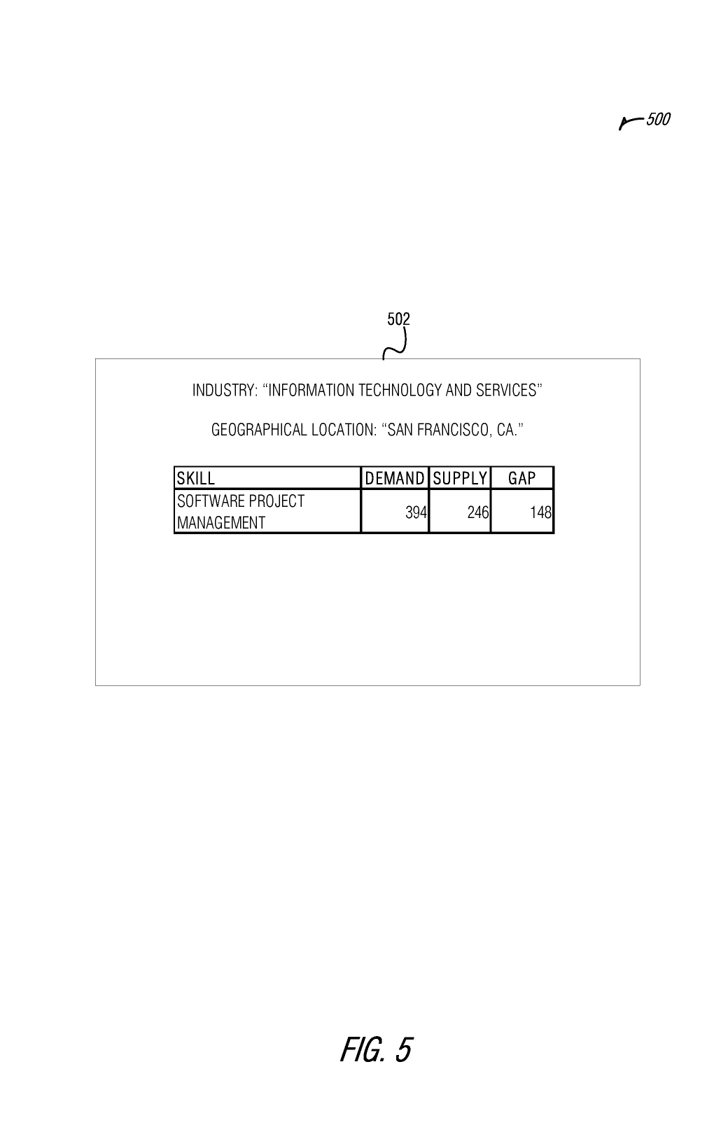

FIG. 5 is an illustration 500 of a workforce skill gap report 502 for a skill, in accordance with some example embodiments. As the workforce skill gap report 502 shows, the data was restricted to the “Information Technology and Services” industry within San Francisco, Calif. The workforce skill gap report 502 shows that, within the “Information Technology and Services” industry of San Francisco, Calif., there are 394 unfilled jobs requiring the skill “Software Project Management,” but only 246 members possessing this skill; thus, there is a workforce skill gap of 148 unfilled jobs.

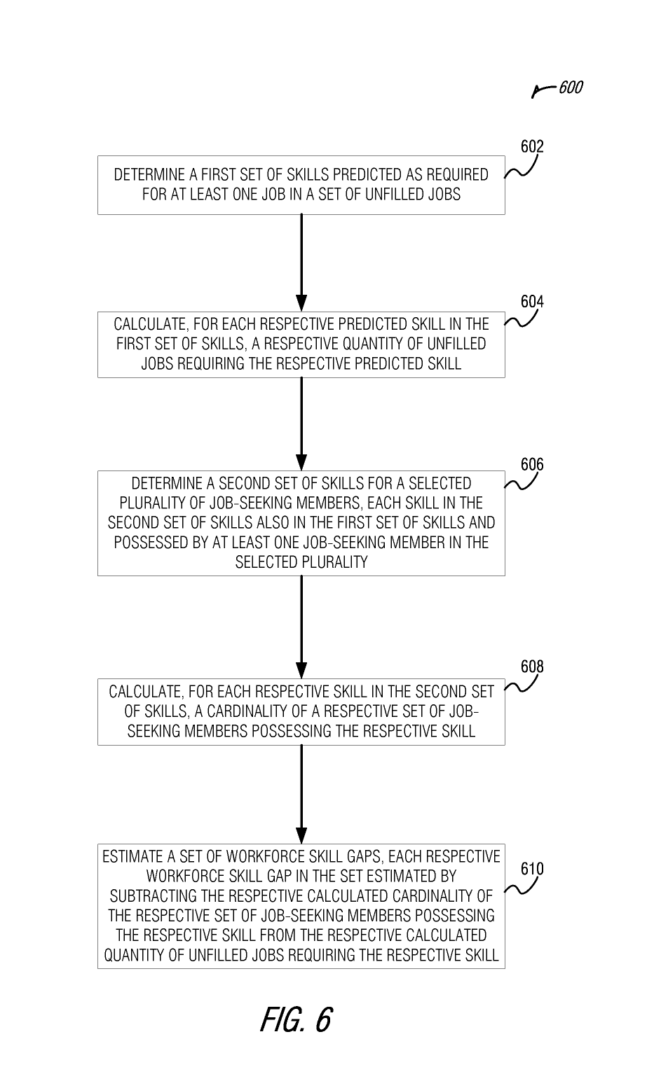

FIG. 6 is a flowchart illustrating another example of operations of a skills gap estimation module performing a method 600 for estimating a set of workforce skill gaps for a set of skills, in accordance with some example embodiments. As used herein, a set includes zero or more members.

At 602, a first set of skills for a set of unfilled jobs is determined. Each skill in the first set of skills is predicted as being required for at least one unfilled job in the set of unfilled jobs. In some embodiments, the predicting is performed by determining, for each skill in the first set of skills, that at least one member of a selected set of members has used the social network service to view at least one electronic job posting for an unfilled job in the set of unfilled jobs, and that each member of the set of members has an electronic profile on the social network service listing the skill as possessed by the member.

In some embodiments, the first set of skills is limited to those skills predicted as required by minimum number of unfilled jobs (e.g., 10 or more unfilled jobs). This can be done to prevent skills with low demand from being included in the first set of skills.

At 604, for each predicted skill in the first set of skills, a quantity of unfilled jobs requiring the predicted skill is calculated. Each calculated quantity of unfilled jobs represents the employment “demand” for the respective predicted skill. Thus, a set of quantities of unfilled jobs is calculated at 604.

In some embodiments, each unfilled job requiring a predicted skill in the first set of skills is selected, at least partially, based on at least one employment industry assigned to the electronic job posting representing the unfilled job. For example, each selected unfilled job may be assigned to the “information technology and services” industry. Thus, in this example, each calculated quantity of selected unfilled jobs in the set of calculated quantities represents the employment “demand” for the respective predicted skill within the “information technology and services” industry.

In some embodiments, each unfilled job requiring a predicted skill is selected, at least partially, based on at least one geographical region assigned to the unfilled job. For example, each selected unfilled job may be located, primarily or otherwise, in “San Jose, Calif.” Thus, in this example, each calculated quantity of selected unfilled jobs in the set of calculated quantities represents the employment “demand” for the respective predicted skill within San Jose, Calif.

At 606, a second set of skills is determined for a selected plurality of job-seeking members. Each skill in the second set of skills is listed on at least one electronic profile of a job-seeking member in the selected plurality of job-seeking members, and each skill in the second set of skills is also in the first set of skills (which was determined at 602).

In some embodiments, each skill in the second set of skills is selected, at least partially, based on a percentage of members of the selected plurality of job-seeking members having an electronic profile listing the respective skill as possessed by the member (e.g., only those predicted skills listed on at least 25% of profiles of the plurality of job seeking members). This can be done to prevent skills possessed by too few members from being included in the second set of skills.

At 608, for each skill in the second set of skills, a cardinality of a set of job-seeking members is calculated. In some embodiments, each member within a set of job-seeking members has an “active” job-seeking propensity, a “passive” job-seeking propensity, or some combination thereof. In some embodiments, each job-seeking member within a respective set of job-seeking members has an electronic profile, on the social network service, listing the respective predicted skill as possessed by the selected job-seeking member. Each respective calculated cardinality of a respective set of job-seeking members represents the employment “supply” for the respective predicted skill.

At 610, a set of workforce skill gaps is estimated. In some embodiments, each workforce skill gap in the set of workforce skill gaps is estimated by subtracting the respective calculated cardinality of the respective set of job-seeking members possessing the skill (“supply,” calculated at 608) from the calculated quantity of unfilled jobs requiring the skill (“demand,” calculated at 604). The result is a set of workforce skill gaps, each respective workforce skill gap representing the difference between the respective quantity of unfilled jobs requiring the respective skill and the respective quantity of job-seeking members possessing the respective skill.

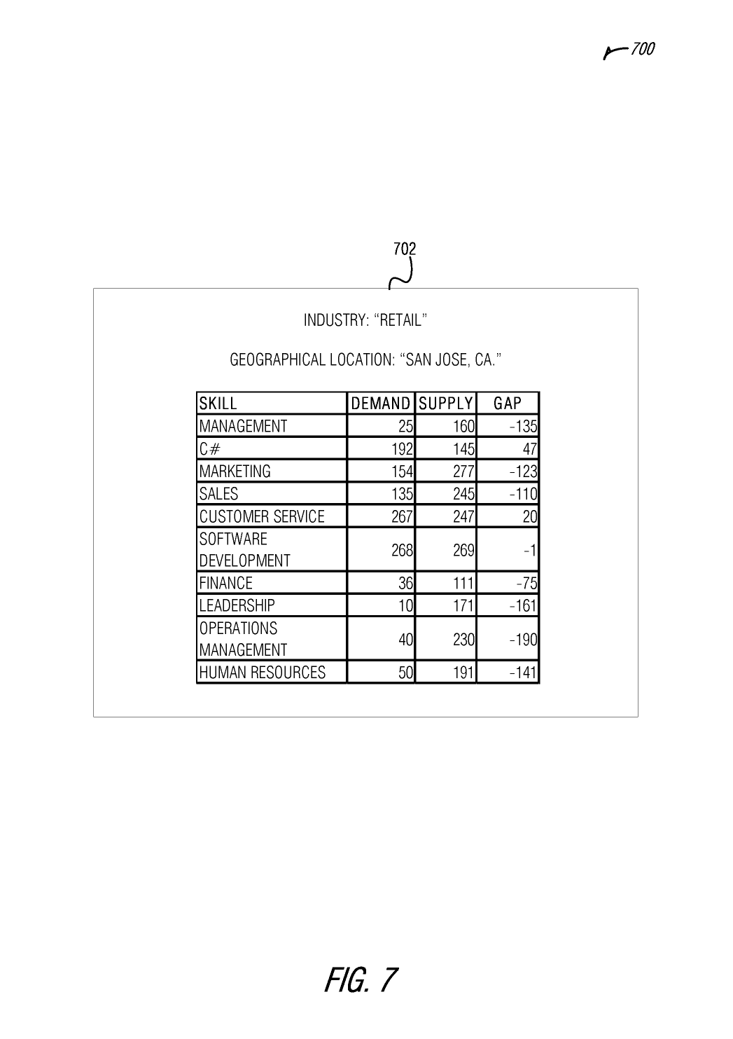

FIG. 7 is an illustration 700 of a workforce skill gap report 702 for a set of skills, in accordance with some example embodiments. As the workforce skill gap report 702 shows, the data was restricted to the “Retail” industry within San Jose, Calif. The workforce skill gap report 702 shows that, within the “Retail” industry of San Jose, Calif., there are only 154 unfilled jobs requiring the skill “Marketing,” but there are 277 members possessing this skill; thus, there is a workforce skill gap of −123 unfilled jobs, signifying that there are more job-seeking members possessing “Marketing” as a skill than there are unfilled jobs requiring “Marketing” as a skill.

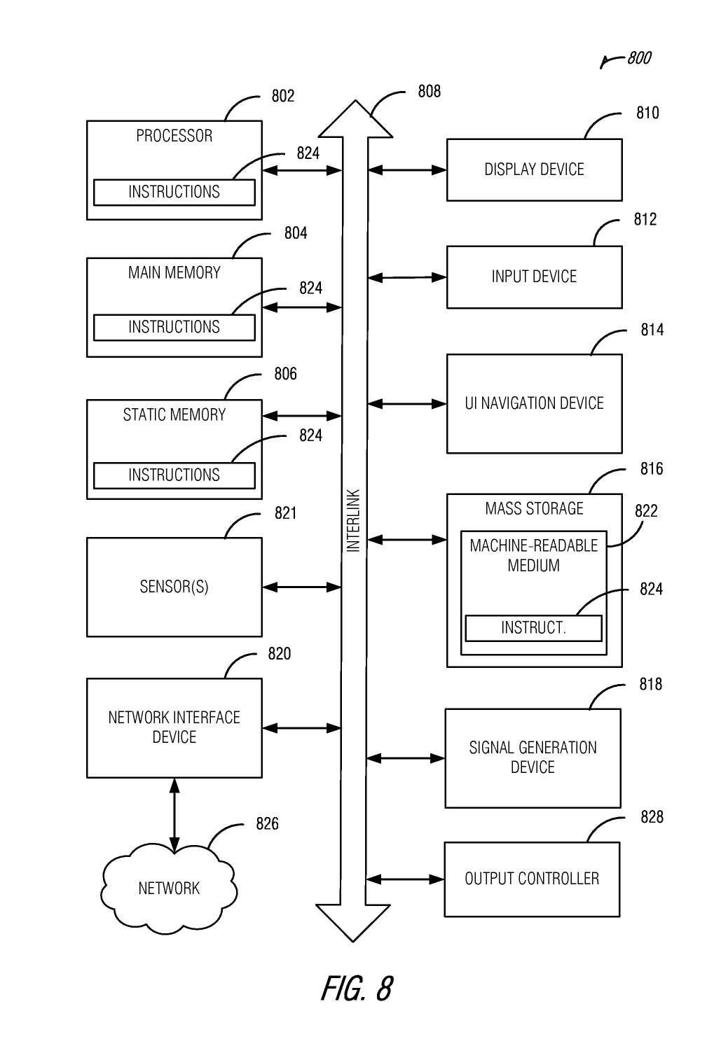

FIG. 8 is a block diagram illustrating an example of a machine 800, upon which any one or more example embodiments may be implemented. In alternative embodiments, the machine 800 may operate as a standalone device or may be connected (e.g., networked) to other machines. In a networked deployment, the machine 800 may operate in the capacity of a server machine, a client machine, or both in a client-server network environment. In an example, the machine 800 may act as a peer machine in a peer-to-peer (P2P) (or other distributed) network environment. The machine 800 may implement or include any portion of the social network service from FIG. 3, and may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, although only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations, etc.

Examples, as described herein, may include, or may operate by, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.)

The storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine-readable media.

Although the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes & Example Embodiments

Example 1 includes subject matter (such as a method, means for performing acts, machine readable medium including instructions that when performed by a machine cause the machine to performs acts, or an apparatus to perform) comprising: using one or more computer processors to perform operations of: predicting a skill as being required for an unfilled job, the unfilled job represented by an electronic job posting on a social network, the predicting performed by determining that each respective member of a selected plurality of members of the social network has used the social network to view the electronic job posting and has a respective electronic profile listing the skill; calculating a quantity of selected unfilled jobs on the social network requiring the predicted skill; calculating a quantity of selected job-seeking members of the social network, each respective job-seeking member having a respective electronic profile on the social network listing the predicted skill as possessed by the respective member; and estimating a workforce skill gap for the predicted skill by subtracting the calculated quantity of job-seeking members possessing the predicted skill from the calculated quantity of unfilled jobs requiring the predicted skill.

In Example 2, the subject matter of Example 1 may include, wherein each unfilled job requiring the predicted skill is selected at least partially based on at least one of an employment industry corresponding to the unfilled job and a geographical region corresponding to the unfilled job.

In Example 3, the subject matter of any one of Examples 1 to 2 may include, wherein each job-seeking member is selected at least partially based on a geographical region corresponding to at least one of the job-seeking member and the selected unfilled jobs.

In Example 4, the subject matter of any one of Examples 1 to 3 may include, wherein the job-seeking member resides in the geographical region.

In Example 5, the subject matter of any one of Examples 1 to 4 may include, wherein the selected unfilled jobs are located in the geographical region.

In Example 6, the subject matter of any one of Examples 1 to 5 may include, wherein each job-seeking member is selected at least partially based on an employment industry of the job-seeking member.

In Example 7, the subject matter of any one of Examples 1 to 6 may include, wherein each selected job-seeking member is classified as an active job-seeking member within the social network.

In Example 8, the subject matter of any one of Examples 1 to 7 may include, wherein the selected plurality of members of the social network is chosen based upon numerosity.

Example 9 includes subject matter (such as a device, apparatus, or machine) comprising: a machine including a processor; and a machine-readable medium including machine-readable instructions which, when executed by the machine, cause the machine to perform operations comprising: predicting a skill as being required for an unfilled job, the unfilled job represented by an electronic job posting on a social network, the predicting performed by determining that each respective member of a selected plurality of members of the social network has used the social network to view the electronic job posting and has a respective electronic profile listing the skill; calculating a quantity of selected unfilled jobs on the social network requiring the predicted skill; calculating a quantity of selected job-seeking members of the social network, each respective job-seeking member having a respective electronic profile on the social network listing the predicted skill as possessed by the respective member; and estimating a workforce skill gap for the predicted skill by subtracting the calculated quantity of job-seeking members possessing the predicted skill from the calculated quantity of unfilled jobs requiring the predicted skill.

In Example 10, the subject matter of Example 9 may include, wherein each unfilled job requiring the predicted skill is selected at least partially based on at least one of an employment industry corresponding to the unfilled job and a geographical region corresponding to the unfilled job.

In Example 11, the subject matter of any one of Examples 9 to 10 may include, wherein each job-seeking member is selected at least partially based on a geographical region corresponding to at least one of the job-seeking member and the selected unfilled jobs.

In Example 12, the subject matter of any one of Examples 9 to 11 may include, wherein the job-seeking member resides in the geographical region.

In Example 13, the subject matter of any one of Examples 9 to 12 may include, wherein the selected unfilled jobs are located in the geographical region.

In Example 14, the subject matter of any one of Examples 9 to 13 may include, wherein each job-seeking member is selected at least partially based on an employment industry of the job-seeking member.

In Example 15, the subject matter of any one of Examples 9 to 14 may include, wherein each selected job-seeking member is classified as an active job-seeking member within the social network.

In Example 16, the subject matter of any one of Examples 9 to 15 may include, wherein the selected plurality of members of the social network is chosen based upon numerosity.

Example 17 includes subject matter (such as a CRM) comprising: predicting a skill as being required for an unfilled job, the unfilled job represented by an electronic job posting on a social network, the predicting performed by determining that each respective member of a selected plurality of members of the social network has used the social network to view the electronic job posting and has a respective electronic profile listing the skill; calculating a quantity of selected unfilled jobs on the social network requiring the predicted skill; calculating a quantity of selected job-seeking members of the social network, each respective job-seeking member having a respective electronic profile on the social network listing the predicted skill as possessed by the respective member; and estimating a workforce skill gap for the predicted skill by subtracting the calculated quantity of job-seeking members possessing the predicted skill from the calculated quantity of unfilled jobs requiring the predicted skill.

In Example 18, the subject matter of Example 17 may include, wherein each unfilled job requiring the predicted skill is selected at least partially based on at least one of an employment industry corresponding to the unfilled job and a geographical region corresponding to the unfilled job.

In Example 19, the subject matter of any one of Examples 17 to 18 may include, wherein each job-seeking member is selected at least partially based on a geographical region corresponding to at least one of the job-seeking member and the selected unfilled jobs.

In Example 20, the subject matter of any one of Examples 17 to 19 may include, wherein the job-seeking member resides in the geographical region.

In Example 21, the subject matter of any one of Examples 17 to 20 may include, wherein the selected unfilled jobs are located in the geographical region.

In Example 22, the subject matter of any one of Examples 17 to 21 may include, wherein each job-seeking member is selected at least partially based on an employment industry of the job-seeking member.

In Example 23, the subject matter of any one of Examples 17 to 22 may include, wherein each selected job-seeking member is classified as an active job-seeking member within the social network.

In Example 24, the subject matter of any one of Examples 17 to 23 may include, wherein the selected plurality of members of the social network is chosen based upon numerosity.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein, in some example embodiments, may comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but also deployed across a number of machines or computers. In some example embodiments, the processor or processors may be located in a single location (e.g., within a home environment, an office environment, at a server farm, etc.), while in other embodiments, the processors may be distributed across a number of locations.

The one or more processors may also operate to support performance of the relevant operations in a “cloud computing” environment or within the context of software as a service (“SaaS”). For example, at least some of the operations may be performed by a group of computers (as examples of machines including processors), these operations being accessible via a network (e.g., the Internet) and via one or more appropriate interfaces (e.g., Application Program Interfaces (APIs)).

Conventional terms in the fields of computer networking and computer systems have been used herein. The terms are known in the art and are provided only as a non-limiting example for convenience purposes. Accordingly, the interpretation of the corresponding terms in the claims, unless stated otherwise, is not limited to any particular definition.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Moreover, in the following claims, the terms “first,” “second,” and “third,” etc. are used merely as labels, and are not intended to impose numerical requirements on their objects.

1. A method comprising:
using one or more computer processors to perform operations of:
for each electronic job posting in a set of electronic job postings on a social network: designating a skill as being required for an unfilled job represented by the electronic job posting, the designating performed by determining that each respective member of a selected plurality of members of the social network:
has used the social network to view the electronic job posting; and
has a respective electronic profile listing the designated skill as possessed by the respective member;
calculating a quantity of selected electronic job postings from the set of electronic job postings requiring the designated skill;
calculating a quantity of selected electronic profiles on the social network, each respective electronic profile:
representing a respective job-seeking member of the social network; and
listing the designated skill as possessed by the respective job-seeking member;
calculating an estimated workforce skill gap of the designated skill by subtracting the calculated quantity of selected electronic profiles listing the designated skill from the calculated quantity of selected electronic job postings designated as requiring the designated skill; and
generating a user interface, including the estimated workforce skill gap, to be presented to a user of the social network.

2. The method of claim 1, wherein each unfilled job requiring the designated skill is selected at least partially based on at least one of an employment industry corresponding to the unfilled job and a geographical region corresponding to the unfilled job.

3. The method of claim 1, wherein each job-seeking member is selected at least partially based on a geographical region corresponding to at least one of the job-seeking member and the selected unfilled jobs.

4. The method of claim 3, wherein the job-seeking member resides in the geographical region.

5. The method of claim 3, wherein the selected unfilled jobs are located in the geographical region.

6. The method of claim 1, wherein each job-seeking member is selected at least partially based on an employment industry of the job-seeking member.

7. The method of claim 1, wherein each selected job-seeking member is classified as an active job-seeking member within the social network.

8. The method of claim 1, wherein the selected plurality of members of the social network is chosen based upon numerosity.

9. A social networking system comprising:
a machine including a processor; and
a machine-readable medium including machine-readable instructions that, when executed by the machine, cause the machine to perform operations comprising:
for each electronic job posting in a set of electronic job postings on a social network: designating a skill as being required for an unfilled job represented by the electronic job posting, the designating performed by determining that each respective member of a selected plurality of members of the social network:
has used the social network to view the electronic job posting; and
has a respective electronic profile listing the designated skill as possessed by the respective member;
calculating a quantity of selected electronic job postings from the set of electronic job postings requiring the designated skill as possessed by the respective member;
calculating a quantity of selected electronic profiles on the social network, each respective electronic profile:
representing a respective job-seeking member of the social network; and
listing the designated skill as possessed by the respective job-seeking member;
calculating an estimated workforce skill gap of the designated skill by subtracting the calculated quantity of selected electronic profiles listing the designated skill from the calculated quantity of selected electronic job postings designated as requiring the designated skill; and
generating a user interface, including the estimated workforce skill gap, to be presented to a user of the social network.

10. The social networking system of claim 9, wherein each unfilled job requiring the designated skill is selected at least partially based on at least one of an employment industry corresponding to the unfilled job and a geographical region corresponding to the unfilled job.

11. The social networking system of claim 9, wherein each job-seeking member is selected at least partially based on a geographical region corresponding to at least one of the job-seeking member and the selected unfilled jobs.

12. The social networking system of claim 11, wherein the job-seeking member resides in the geographical region.

13. The social networking system of claim 11, wherein the selected unfilled jobs are located in the geographical region.

14. The social networking system of claim 9, wherein each job-seeking member is selected at least partially based on an employment industry of the job-seeking member.

15. The social networking system of claim 9, wherein each selected job-seeking member is classified as an active job-seeking member within the social network.

16. The social networking system of claim 9, wherein the selected plurality of members of the social network is chosen based upon numerosity.

17. A non-transitory machine-readable storage medium including instructions that, when executed by a processor of a machine, cause the machine to perform operations comprising:
for each electronic job posting in a set of electronic job postings on a social network: designating a skill as being required for an unfilled job represented by the electronic job posting, the designating performed by determining that each respective member of a selected plurality of members of the social network:
has used the social network to view the electronic job posting; and
has a respective electronic profile listing the designated skill as possessed by the respective member;
calculating a quantity of selected electronic job postings from the set of electronic job postings requiring the designated skill;
calculating a quantity of selected electronic profiles on the social network, each respective electronic profile:
representing a respective job-seeking member of the social network; and
listing the designated skill as possessed by the respective job-seeking member;
calculating an estimated workforce skill gap of the designated skill by subtracting the calculated quantity of selected electronic profiles listing the designated skill from the calculated quantity of selected electronic job postings designated as requiring the designated skill; and
generating a user interface, including the estimated workforce skill gap, to be presented to a user of the social network.

18. The non-transitory machine-readable storage medium of claim 17, wherein each unfilled job requiring the designated skill is selected at least partially based on at least one of an employment industry corresponding to the unfilled job and a geographical region corresponding to the unfilled job.

19. The non-transitory machine-readable storage medium of claim 17, wherein each job-seeking member is selected at least partially based on a geographical region corresponding to at least one of the job-seeking member and the selected unfilled jobs.

20. The non-transitory machine-readable storage medium of claim 19, wherein the job-seeking member resides in the geographical region.

21. The non-transitory machine-readable storage medium of claim 20, wherein the selected unfilled jobs are located in the geographical region.

22. The non-transitory machine-readable storage medium of claim 17, wherein each job-seeking member is selected at least partially based on an employment industry of the job-seeking member.

23. The non-transitory machine-readable storage medium of claim 17, wherein each selected job-seeking member is classified as an active job-seeking member within the social network.

24. The non-transitory machine-readable storage medium of claim 17, wherein the selected plurality of members of the social network is chosen based upon numerosity.
